(19) United States
(12) Patent Application Publication
(10) Pub. No.: US 2004/0100401 A1
(43) Pub. Date: May 27, 2004

(54) Remote controller with a user-programmable command transmit key

(76) Inventor: Apin Chang, Chung-Ho City (TW)

Correspondence Address: TROP PRUNER & HU, PC, 8554 KATY FREEWAY, SUITE 100, HOUSTON, TX, 77024, US

(21) Appl. No.: 10/717,364

(22) Filed: Nov. 19, 2003

Related U.S. Application Data
(63) Continuation-in-part of application No. 09/851,924, filed on May 9, 2001, now abandoned.

(51) Int. Cl. H04L 17/02; G08C 19/12

(52) U.S. Cl. 341/176; 340/825.69; 340/825.72

(57) ABSTRACT

A remote controller capable of transmitting different control signals for controlling an anti-theft device on an automobile includes a casing, a controller circuit, a function key set, and a function display unit. The controller circuit is disposed in the casing and includes a transmitter circuit connected electrically to a processor unit. The function key set is mounted on the casing, is connected electrically to the processor unit, and includes a user-programmable command transmit key operable so as to enable the processor unit to control the transmitter circuit to transmit an assigned control signal. The function display unit is mounted on the casing, and is connected electrically to and controlled by the processor unit to provide a visual indication corresponding to a currently selected one of the control signals.

### CROSS-REFERENCE TO RELATED APPLICATION

This application is a continuation-in-part of U.S. patent application Ser. No. 09/851,924, filed on May 09, 2001.

### BACKGROUND OF THE INVENTION

1. Field of the Invention

The invention relates to a remote controller, more particularly to a remote controller for automobiles that includes a user-programmable command transmit key.

2. Description of the Related Art

A conventional remote controller for automobiles generally includes at least three function keys, which are defined with three different control functions, respectively. In addition, the function keys can be operated simultaneously in pairs to result in three other pre-defined control functions. To aid users in memorizing the available control functions and their associated key combinations, manufacturers generally provide the remote controllers with an appropriate look-up table guide. However, as the number of the available control functions increases, the likelihood of confusion increases as well because the available control functions and the actual number of keys on the remote controller have a many-to-one relationship. Therefore, the user has to rely heavily on the look-up table guide to be able to operate the conventional remote controller properly.

In U.S. Pat. Nos. 4,890,108, 5,774,051, 5,739,747, 5,940,007, and 6,243,022, there are disclosed conventional remote control transmitters that include a housing, a control circuit disposed in the housing, a function key set mounted on the housing and connected to the control circuit, and a function display unit mounted on the housing and connected to the control circuit. The control circuit includes a microprocessor and a transmitter circuit connected to the microprocessor. The function key set includes a select key to enable the microprocessor to select among control signals indicated on the function display unit, and a transmit key that enables the microprocessor to activate the transmitter circuit for transmitting the selected control signal wirelessly. The devices in each of U.S. Pat. Nos. 4,890,108 and 5,774,051 further include an audio output unit that provides an audible output during operation of the function key set.

The function display unit disclosed in U.S. Pat. No. 5,774,051 includes light emitting diodes, and patterns, each of which is disposed adjacent to a respective one of the light emitting diodes and illustrates a control function associated with the respective one of the control signals. The select key enables the microprocessor to control the function display unit to activate the light emitting diode corresponding to a selected one of the control signals accordingly.

The devices in each of U.S. Pat. Nos. 5,739,747, 5,940,007 and 6,243,022 include an icon display to indicate the selected control function.

Moreover, the function key set disclosed in each of U.S. Pat. Nos. 5,739,747, 5,940,007 and 6,243,022 includes preset keys in addition to the select and transmit keys. Each of the preset keys enables the microprocessor to control the transmitter circuit to transmit a predetermined one of the control signals.

Although the aforesaid conventional remote controllers include a function display unit that makes selection of desired control functions possible without the need to memorize key combinations, none of them provides a preset key that can be redefined by the user.

### SUMMARY OF THE INVENTION

Therefore, the object of the present invention is to provide a remote controller that includes a function display unit and a user-programmable command transmit key so as to overcome the aforementioned drawbacks of the prior art.

According to the present invention, a remote controller capable of transmitting different control signals for controlling an anti-theft device on an automobile includes a casing, a controller circuit, a function key set, and a function display unit. The controller circuit is disposed in the casing, and includes a processor unit, and a transmitter circuit connected electrically to and controlled by the processor unit so as to transmit the control signals wirelessly. The function key set is mounted on the casing, is connected electrically to the processor unit, and includes a function select key operable so as to control selection of the control signals by the processor unit, a first command transmit key operable so as to enable the processor unit to control the transmitter circuit to transmit a currently selected one of the control signals, and a user-programmable second command transmit key capable of being assigned with the currently selected one of the control signals and operable so as to enable the processor unit to control the transmitter circuit to transmit an assigned one of the control signals. The function display unit is mounted on the casing, and is connected electrically to and controlled by the processor unit so as to provide a visual indication corresponding to the currently selected one of the control signals.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view showing the first preferred embodiment of a remote controller according to the present invention;

FIG. 2 is a schematic circuit block diagram showing a controller circuit of the first preferred embodiment;

FIG. 3 is a schematic view of a function display unit of the first preferred embodiment;

FIGS. 4 and 5 are schematic views showing a function display unit of the second preferred embodiment of a remote controller according to the present invention; and

FIGS. 6 and 7 are schematic views showing a function display unit of the third preferred embodiment of a remote controller according to the present invention.

### DETAILED DESCRIPTION OF THE PREFERRED EMBODIMENTS

Before the present invention is described in greater detail, it should be noted that like elements are denoted by the same reference numerals throughout the disclosure.

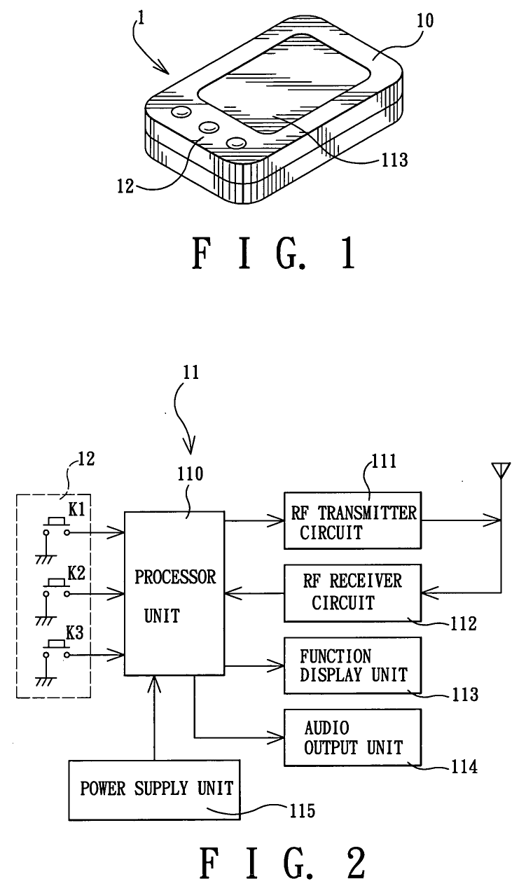

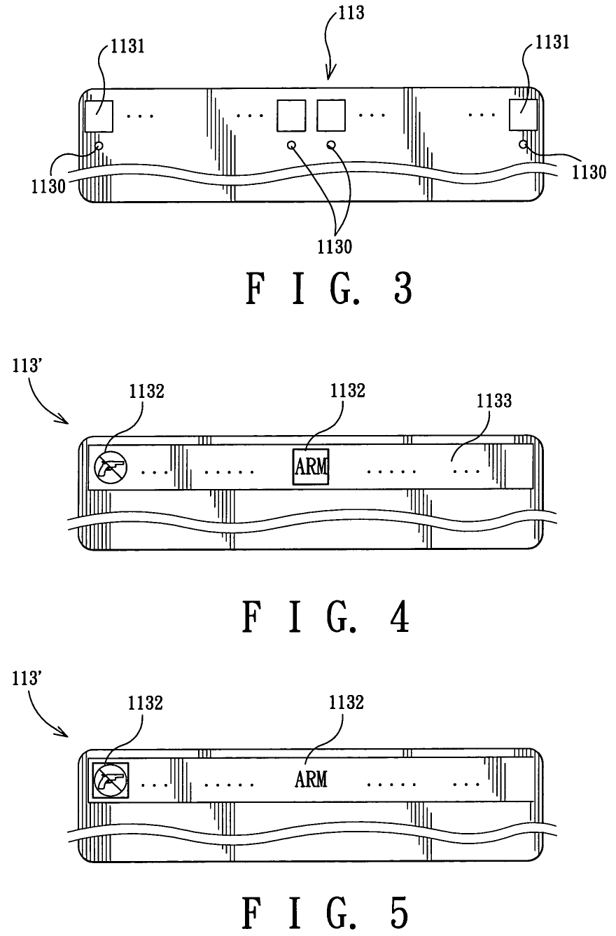

Referring to FIGS. 1 to 3, the first preferred embodiment of a remote controller 1 according to the present invention is shown to include a casing 10, a controller circuit 11, a function key set 12, and a function display unit 113.

The remote controller 1 is adapted to be used for transmitting different control signals to control the operation of an anti-theft device (not shown) on an automobile (not shown).

The controller circuit 11 is mounted on a circuit board (not shown) disposed in the casing 10, and includes a processor unit 110 and a radio frequency (RF) transmitter circuit 111. The transmitter circuit 111 is connected electrically to and controlled by the processor unit 110 so as to transmit the control signals wirelessly.

The controller circuit 11 further includes an RF receiver circuit 112, an audio output unit 114, and a power supply unit 115. The RF receiver circuit 112 is connected electrically to the processor unit 110, and is adapted to receive acknowledge or alarm signals from the anti-theft device and to provide the same to the processor unit 110 in a known manner. The audio output unit 114, such as a buzzer, is connected electrically to and controlled by the processor unit 110 so as to generate an audible output. The power supply unit 115 is connected electrically to the processor unit 110, and supplies electric power to the processor unit 110.

The function key set 12 is mounted on and is externally accessible from casing 10, and is connected electrically to the processor unit 110. In this embodiment, the function key set 12 includes a function select key (K1), a first command transmit key (K2), and a user-programmable second command key (K3) The function select key (K1) is operable so as to control selection of the control signals by the processor unit 110.

The function display unit 113 is mounted on and is externally accessible from the casing 10, and is connected electrically to the processor unit 110. In this embodiment, the function display unit 113 includes a plurality of lamp units 1130, and a plurality of patterns 1131 disposed adjacent to the lamp units 1130, respectively. Each of the lamp units 1130 corresponds to a respective one of the control signals and is activated by the processor unit 110 when the respective one of the control signals is currently selected by the processor unit 110. The lamp units 1130 are preferably light emitting diodes. The patterns 1131 may be in text or graphic form. Each of the patterns 1131 illustrates a control function associated with the control signal of the adjacent lamp unit 1130.

The processor unit 110 is operable in a first command transmission mode, where operation of the first command transmit key (K2), after operation of the function select key (K1) to select one of the control signals and to enable the processor unit 110 to control the function display unit 113 for providing a visual indication corresponding to the currently selected one of the control signals, further enables the processor unit 110 to control the transmitter circuit 111 for transmitting the currently selected one of the control signals. In particular, every time that the function select key (K1) is operated, the processor unit 110 will be enabled to select the control signals sequentially, and will activate the lamp unit 1130 corresponding to the selected one of the control signals accordingly. After selection of the desired control signal to be transmitted, the first command transmit key (K2) is operated so as to enable the processor unit 110 to activate the transmitter circuit 111 so that the currently selected one of the control signals can be transmitted wirelessly for reception by the anti-theft device.

Preferably, whenever one of the control signals is selected, the processor unit 110 further controls the audio output unit 114 to generate an audio output. More preferably, the audio outputs generated by the audio output unit 114 vary for the different control signals.

Moreover, the processor unit 110 is operable in a key programming mode, where operation of the second command transmit key (K3), after operation of the function select key (K1) to select one of the control signals and to enable the processor unit 110 to control the function display unit 113 for providing the visual indication corresponding to the selected one of the control signals, further enables the processor unit 110 to assign the selected one of the control signals to the second command transmit key (K3).

The assignment of one of the control signals to the second command transmit key (K3) includes the following steps:

In step 1, the function select key (K1) is operated by pressing and releasing a number of times to enable the processor unit 110 to select the control signals sequentially and to activate the lamp unit 1130 corresponding to the selected one of the control signals accordingly. After selection of the desired control signal to be assigned, in step 2, the function select key (K1) is operated by pressing and holding for a certain period of time (e.g., six seconds). Finally, in step 3, the second command transmit key (K3) is operated so as to enable the processor unit 110 to assign the currently selected one of the control signals thereto. The second command transmit key (K3) can be reassigned with another one of the control signals by repeating the above steps 1 to 3.

Further, the processor unit 110 is operable in a second command transmission mode, where operation of the second command transmit key (K3), without prior operation of the function select key (K1), enables the processor unit 110 to control the transmitter circuit 111 for transmitting one of the control signals that is assigned to the second command transmit key (K3). In particular, when the second command transmit key (K2) is operated, as long as the function select key (K1) is not operated in accordance with the assignment of one of the control signals to the second command transmit key (K3) as described hereinabove, the processor unit 110 will activate the transmitter circuit 111 so that the currently assigned control signal can be transmitted wirelessly for reception by the anti-theft device.

Referring to FIG. 4, the function display unit 113′ of the second preferred embodiment of a remote controller according to the present invention is shown to include a liquid crystal display 1133 that is configured as a graphic interface for showing a plurality of function icons 1132 thereon. Each of the function icons 1132 is used to illustrate a control function associated with a respective one of the control signals. In this embodiment, the function select key (K1) enables the processor unit 110 to control the function display unit 113′ to highlight one of the function icons 1132 corresponding to the currently selected one of the control signals.

The selection operation of the processor unit 110 proceeds in a manner similar to that of the previous embodiment with the use of the function select key (K1) (see FIG. 2).

As illustrated in FIG. 4, the lock-arming control function is selected, and the corresponding function icon 1132 is highlighted accordingly. The lock-arming control signal is transmitted when the first command transmit key (K2) is operated.

In FIG. 5, the function select key (K1) is operated repeatedly from the state shown in FIG. 4 until the function icon 1132 corresponding to the anti-theft control function is highlighted. Operation of the first command transmit key (K2) at this time will result in transmission of the anti-theft control signal. Like the previous embodiment, whenever one of the control signals is selected, the processor unit 110 further controls the audio output unit 114 to generate an audio output. More preferably, the audio outputs generated by the audio output unit 114 vary for the different control signals.

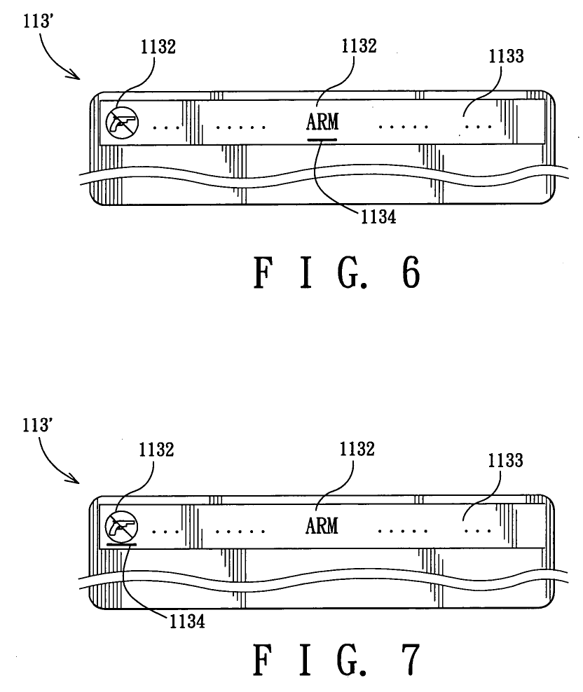

FIG. 6 illustrates the third preferred embodiment of a remote controller according to the present invention. When compared with the second preferred embodiment, instead of highlighting, the function select key (K1) enables the processor unit 110 to control the function display unit 113 to position a cursor 1134 on one of the function icons 1132 corresponding to the currently selected one of the control signals.

The selection operation of the processor unit 110 proceeds in a manner similar to that of the previous embodiment with the use of the function select key (K1) (see FIG. 2).

As illustrated in FIG. 6, the lock-arming control function is selected, and the cursor 1134 is positioned on the corresponding function icon 1132 accordingly. The lock-arming control signal is transmitted when the first command transmit key (K2) is operated.

In FIG. 7, the function select key (K1) is operated repeatedly from the state shown in FIG. 6 until the cursor 1134 is positioned on the function icon 1132 corresponding to the anti-theft control function. Operation of the first command transmit key (K2) at this time will result in transmission of the anti-theft control signal. Like the previous embodiments, whenever one of the control signals is selected, the processor unit 110 further controls the audio output unit 114 to generate an audio output. More preferably, the audio outputs generated by the audio output unit 114 vary for the different control signals.

It has thus been shown that the remote controller 1 of this invention includes a user-programmable command transmit key (K3), the assigned control signal of which can be redefined by the user. Upon operation of the user-programmable command transmit key (K3), the processor unit 110 is enabled to control the transmitter circuit 111 so that a currently assigned control signal is transmitted.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A remote controller capable of transmitting different control signals for controlling an anti-theft device on an automobile, said remote controller comprising:
a casing;
a controller circuit disposed in said casing and including
a processor unit, and
a transmitter circuit connected electrically to and controlled by said processor unit so as to transmit the control signals wirelessly;
a function key set mounted on said casing and connected electrically to said processor unit, said function key set including
a function select key operable so as to control selection of the control signals by said processor unit,
a first command transmit key operable so as to enable said processor unit to control said transmitter circuit to transmit a currently selected one of the control signals, and
a user-programmable second command transmit key capable of being assigned with the currently selected one of the control signals, and operable so as to enable said processor unit to control said transmitter circuit to transmit an assigned one of the control signals; and
a function display unit mounted on said casing and connected electrically to said processor unit, said function display unit being controlled by said processor unit to provide a visual indication corresponding to the currently selected one of the control signals.

2. The remote controller as claimed in claim 1, wherein said function display unit includes:
a plurality of lamp units, each of which corresponds to a respective one of the control signals and is activated by said processor unit when the respective one of the control signals is currently selected by said processor unit; and
a plurality of patterns, each of which is disposed adjacent to a respective one of said lamp units and illustrates a control function associated with the respective one of the control signals.

3. The remote controller as claimed in claim 1, wherein said function display unit includes a liquid crystal display for showing a plurality of function icons thereon, each of said function icons illustrating a control function associated with a respective one of the control signals.

4. The remote controller as claimed in claim 3, wherein said function select key enables said processor unit to control said function display unit to highlight one of said function icons corresponding to the currently selected one of the control signals.

5. The remoter controller as claimed in claim 3, wherein said function select key enables said processor unit to control said function display unit to position a cursor on one of said function icons corresponding to the currently selected one of the control signals.

6. The remote controller as claimed in claim 1, wherein said controller circuit further includes an audio output unit connected to and controlled by said processor unit so as to generate an audio output whenever one of the control signals is selected by said processor unit.

7. A remote controller capable of transmitting different control signals for controlling an anti-theft device on an automobile, said remote controller comprising:
a casing;
a controller circuit disposed in said casing and including a processor unit and a transmitter circuit coupled to and controlled by said processor unit so as to transmit the control signals wirelessly;
a function key set mounted on said casing and coupled to said processor unit; and
a function display unit mounted on said casing and coupled to said processor unit;
said function key set including a function select key operable so as to control selection of the control signals by said processor unit, a first command transmit key, and a user-programmable second command transmit key;
said processor unit being operable in one of
a first command transmission mode, where operation of said first command transmit key, after operation of said function select key to select one of the control signals and to enable said processor unit to control said function display unit for providing a visual indication corresponding to the selected one of the control signals, further enables said processor unit to control said transmitter circuit for transmitting the selected one of the control signals,
a key programming mode, where operation of said second command transmit key, after operation of said function select key to select one of the control signals and to enable said processor unit to control said function display unit for providing the visual indication corresponding to the selected one of the control signals, further enables said processor unit to assign the selected one of the control signals to said second command transmit key, and
a second command transmission mode, where operation of said second command transmit key without prior operation of said function select key enables said processor unit to control said transmitter circuit for transmitting one of the control signals that is assigned to said second command transmit key.

8. The remote controller as claimed in claim 7, wherein said function display unit includes:
a plurality of lamp units, each of which corresponds to a respective one of the control signals and is activated by said processor unit when the respective one of the control signals is currently selected by said processor unit; and
a plurality of patterns, each of which is disposed adjacent to a respective one of said lamp units and illustrates a control function associated with the respective one of the control signals.

9. The remote controller as claimed in claim 7, wherein said function display unit includes a liquid crystal display for showing a plurality of function icons thereon, each of said function icons illustrating a control function associated with a respective one of the control signals.

10. The remote controller as claimed in claim 9, wherein said function select key enables said processor unit to control said function display unit to highlight one of said function icons corresponding to a currently selected one of the control signals.

11. The remoter controller as claimed in claim 9, wherein said function select key enables said processor unit to control said function display unit to position a cursor on one of said function icons corresponding to a currently selected one of the control signals.

12. The remote controller as claimed in claim 7, wherein said controller circuit further includes an audio output unit coupled to and controlled by said processor unit so as to generate an audio output whenever one of the control signals is selected by said processor unit.
